(19) United States
(12) Patent Application Publication
(10) Pub. No.: US 2010/0185519 A1
(43) Pub. Date: Jul. 22, 2010

(54) System and method for presenting relevant contextual advertisements in microblogging services

(76) Inventor: Satyanarayanan Ramaswamy, Cupertino, CA (US)

Correspondence Address: BRIGHTFON, INC, 7563 HOLLANDERRY PL, CUPERTINO, CA, 95014, US

(21) Appl. No.: 12/657,358

(22) Filed: Jan. 18, 2010

Related U.S. Application Data
(60) Provisional application No. 61/205,470, filed on Jan. 20, 2009.

(51) Int. Cl. G06Q 30/00; G06F 17/30

(52) U.S. Cl. 705/14.58; 707/758; 705/14.66; 705/14.49; 707/E17.014

(57) ABSTRACT

This invention relates in general to microblogging services and more specifically to a system and method for providing relevant, contextual advertisements to users of such microblogging services. The system in this invention comprises of a user-device, a microblog server, and an advertisement server. Contextual cues that show the preferences and needs of the user are derived based on his own microblogs, the microblogs of other users who are following the user's microblogs and the microblogs of users whose microblogs the user is following. The ‘following’ and ‘followed by’ relationships in the microblogging system are also analyzed to extract the interests of the user at the current time. The trends and topics that are most popular among the microblogs in the whole microblogging system or those that are most popular in the specific geographical area where the user is located are also used to select the advertisements. The advertisements are prioritized to maximize the commercial value to the microblogging service and also based on the user's location.

I HEREBY CLAIM PRIORITY TO MY EARLIER FILED PROVISIONAL PATENT APPLICATION WITH APPLICATION No. 61/205,470 WITH FILING-OR-371(c) DATE: Jan. 20, 2009

### CROSS-REFERENCE TO RELATED APPLICATIONS

Not Applicable

### FIELD OF THE INVENTION

This invention relates in general to microblogging services and more specifically to a system and method for providing relevant, contextual advertisements to users of such microblogging services. This invention derives useful contextual information by automatically analyzing several cues, about a users' preferences and needs, based on his use of the microblogging service and then uses such contextual information to select relevant advertisements for that user.

### BACKGROUND OF THE INVENTION

Microblogging services have become popular over the past few years. Such services allow a user to enter short messages (called microblogs) about what they are doing at that moment, or more generally a comment, question, or a thought they may have. This message is then available publicly to the user's ‘followers’ who have expressed an interest in the user's microblogs. Microblogging services allow access from a variety of devices such as mobile phones, PC, etc. Microblogging services can be general-purpose in nature or they could be related to a specific topic or service. An example of a microblogging service centered around a specific topic would be a microblogging service centered around shopping, where users could comment about what they are planning on shopping, what they have shopped, what products they like, why they like it, etc. Such microblogs could be very valuable to the user's circle of friends and family in getting valuable advice and information. Since users share their thoughts, and many times their needs, on the microblogging service, it could become an effective medium for advertisers—provided the advertisements are contextual and are highly relevant to the user.

In this invention, we present a system and method for presenting relevant contextual advertisements in microblogging services. This is done in a non-intrusive manner by observing user actions on the microbloging service and selecting advertisements that are relevant to that user based on the user's actions. A user's interaction with the microblogging service provides a number of useful and actionable cues that assist in such a passive approach to selecting relevant advertisements for that user. This is performed in a fully anonymous manner, so that no personally identifiable information about the user is used.

### BRIEF SUMMARY OF THE INVENTION

This invention performs an automated analysis of the interaction of users with microblogging services to provide relevant contextual advertisements to individual users. A user's interaction with his microblogging service provides a rich set of cues on the wants, needs, and preferences of the user. The user's own microblogs, the microblogs of others to which he has subscribed to, his use of sentence structure and language, and recurring time patterns in his microblogs on certain activities, etc provide cues as to which advertisements may be most relevant to that user and hence will be acted upon by the user.

Therefore consistent with one aspect of this invention, keywords are extracted from the microblogs to which the user has subscribed to and then matched with keywords of advertisements to determine the relevant advertisements for the user.

Consistent with another aspect of this invention, keywords are extracted from the user's own microblogs and then matched with keywords of advertisements to determine the relevant advertisements for the user.

Consistent with another aspect of this invention, the user's microblogs are analyzed using natural language processing techniques to identify underlying needs and then advertisements for products that address those needs are determined.

Consistent with another aspect of this invention, the user's microblogs are analyzed to identify the relationship between specific times and user activities at those times by analyzing the user's microblogs over a period of time. This information is then used to match advertisements suited for specific activities at the times when the user is likely to be engaging in those activities.

Consistent with another aspect of this invention, the microblogs in the microblogging service are monitored for rise in the activity on certain topics. Advertisements that relate to those topics are selected for display to the user, if the user has microbloged or subscribed to microblogs on that topic.

Consistent with another aspect of this invention, the user's microblogs are analyzed to identify sentence structure, slangs, and products discussed, which are then matched with likely demographies that use them. Advertisements are then selected based on the demographic match as requested by advertisers.

Consistent with another aspect of this invention, the “following” and “followed by” relationships of the user are analyzed to identify topics of interest to the user. Advertisements are then selected based on the topics of interest to the user and topics indicated by the advertisers for their advertisements.

### BRIEF DESCRIPTION OF THE SEVERAL VIEWS OF THE DRAWINGS

FIG. 1 is an exemplary simplified semi-schematic block diagram of a user device in accordance with this invention.

FIG. 2 is an exemplary simplified semi-schematic block diagram of a network-based Microblog Server system in accordance with this invention.

FIG. 3 is an exemplary simplified semi-schematic block diagram of a network-based Advertisement Server system in accordance with this invention.

FIG. 4 is an example of advertisement selection based on keywords in the microblogs to be displayed to the user.

FIG. 5 is an example of advertisement selection based on keywords in the microblogs generated by the user.

FIG. 6 is an example of advertisement selection based on needs analysis based on the microblogs generated by the user.

FIG. 7 is an example of advertisement selection based on time-based activity analysis of the microblogs generated by the user.

FIG. 8 is an illustration of “following” and “followed by” relationship in the microblogging service for an exemplary user.

### DETAILED DESCRIPTION OF THE INVENTION

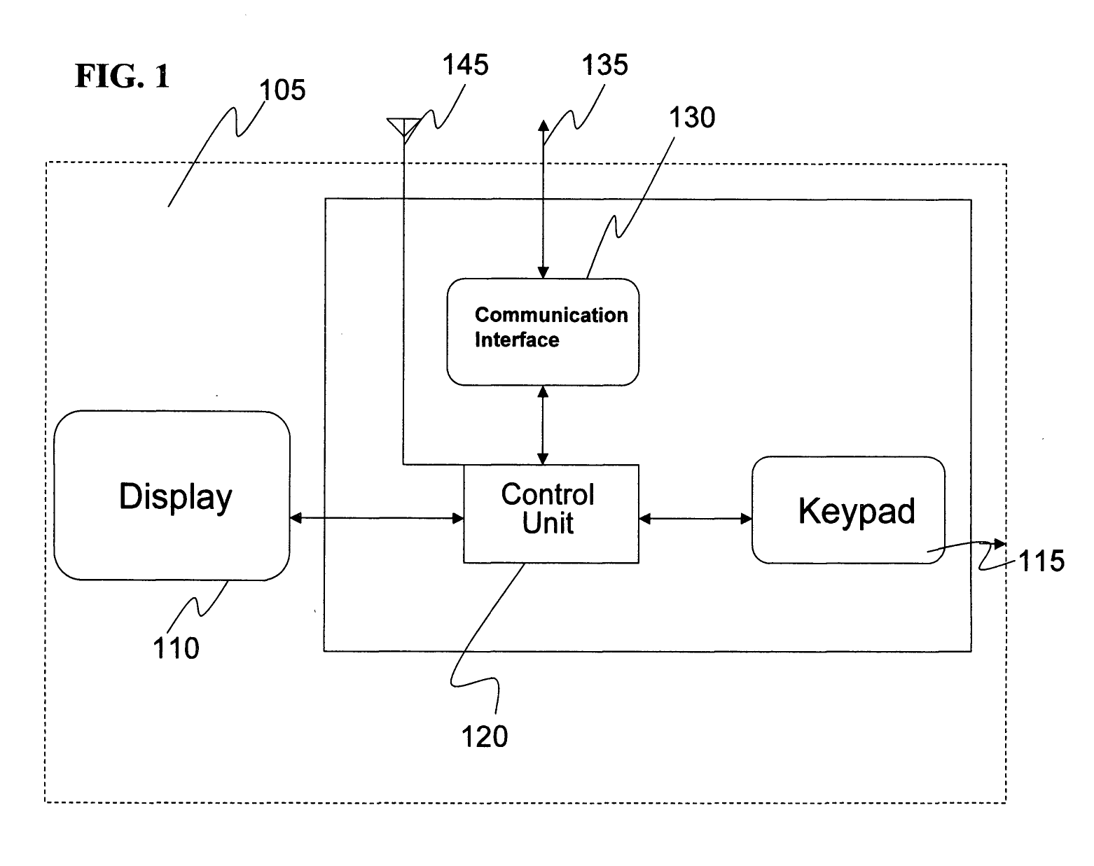

FIG. 1 presents a simplified semi-schematic block diagram of a user device 105 operable in accordance with this invention. As illustrated in FIG. 1, the user device consists of a display 110 that is used to display system responses and messages to the user, including microblogs and advertisements. The user device has a keypad 115 used to obtain user-typed inputs to the system, such as microblogs. This keypad could be a physical keypad or it could be a soft keypad which is displayed on a touch sensitive display 110 and whose keys are activated by the shopper touching the appropriate displayed key. The user device has a control unit 120 that controls all other parts of the user device with either software and/or hardware commands. The user device-side logic of the system as embodied in this invention is performed by this control unit. The control unit is also connected to a communication link 135 that is used to communicate with the Microblog Server system 205 and Advertisement Server system 305 via a communication interface 130. Any one of a variety of wireless or wireline technologies can be used to provide the communication link to/from the user device. In one embodiment of this invention, the user device also has a GPS receiver 145 using which the device can determine its unique global position at any time and communicate the same to the Advertisement Server system 305.

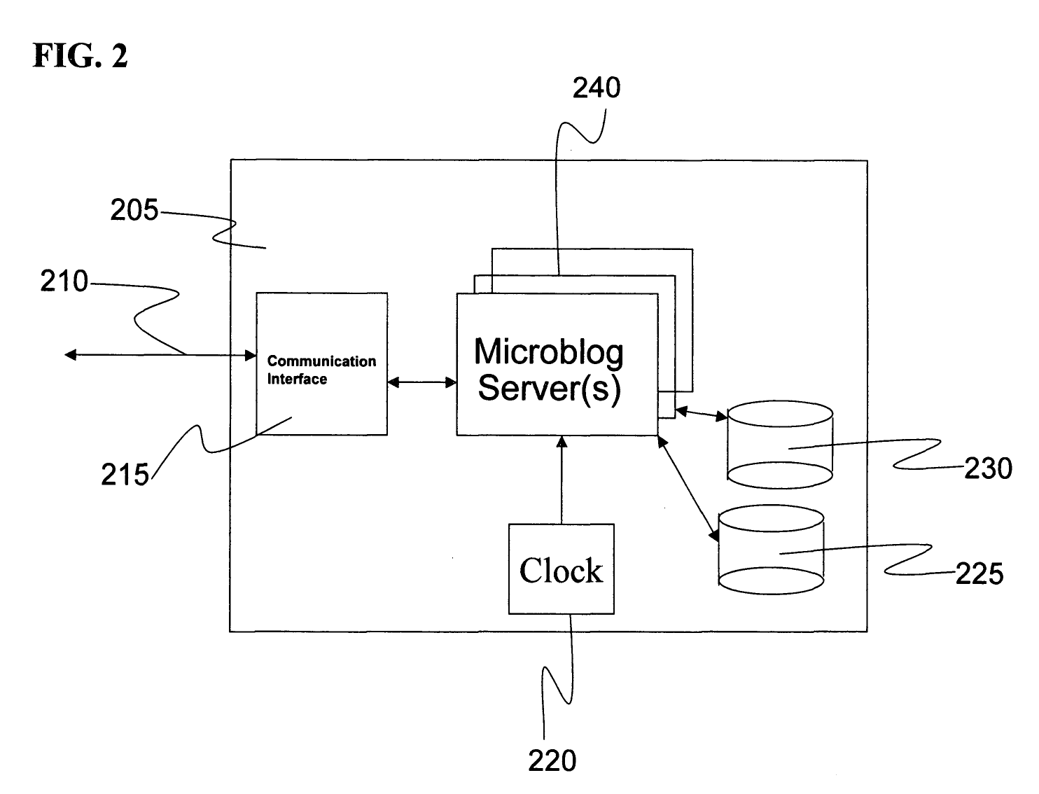

FIG. 2 presents a simplified semi-schematic block diagram of a Microblog Server system 205 in accordance with this invention. The Microblog Server system is connected to a plurality of user devices 105 via the communication link 210 and a communication interface 215. The Microblog Server system consists of one or more Microblog Server(s) 240 that perform storage and retrieval of microblogs as in this invention. Each Microblog Server is connected to a microblog store 225 where the microblogs are stored along with additional information such as the user id identifying the user who generated the given microblog and the time at which the microblog was generated. The time at which the microblog is generated by the user is obtained from clock 220. The Microblog Server System is connected to a User Relationship database 230 that establishes the relationship between the users in the system in terms of which users are following whom in terms of interest in each other's microblogs. For example, if a given user A has expressed interest in following the microblogs of users B, C, and D, then this information is represented in the User Relationship database 230. In addition, if users G, H, I and J have expressed interest in following the microblogs of A, then this information is also represented in the User Relationship database 230. The Microblog Server system 205 may also be connected to Advertisement Server system 305 via the communication link 210. It will be appreciated that FIG. 2 is not prescriptive in terms of the software or hardware architecture to be used to derive the benefits of this invention. The functional elements in FIG. 2 may be distributed across multiple hardware and software systems.

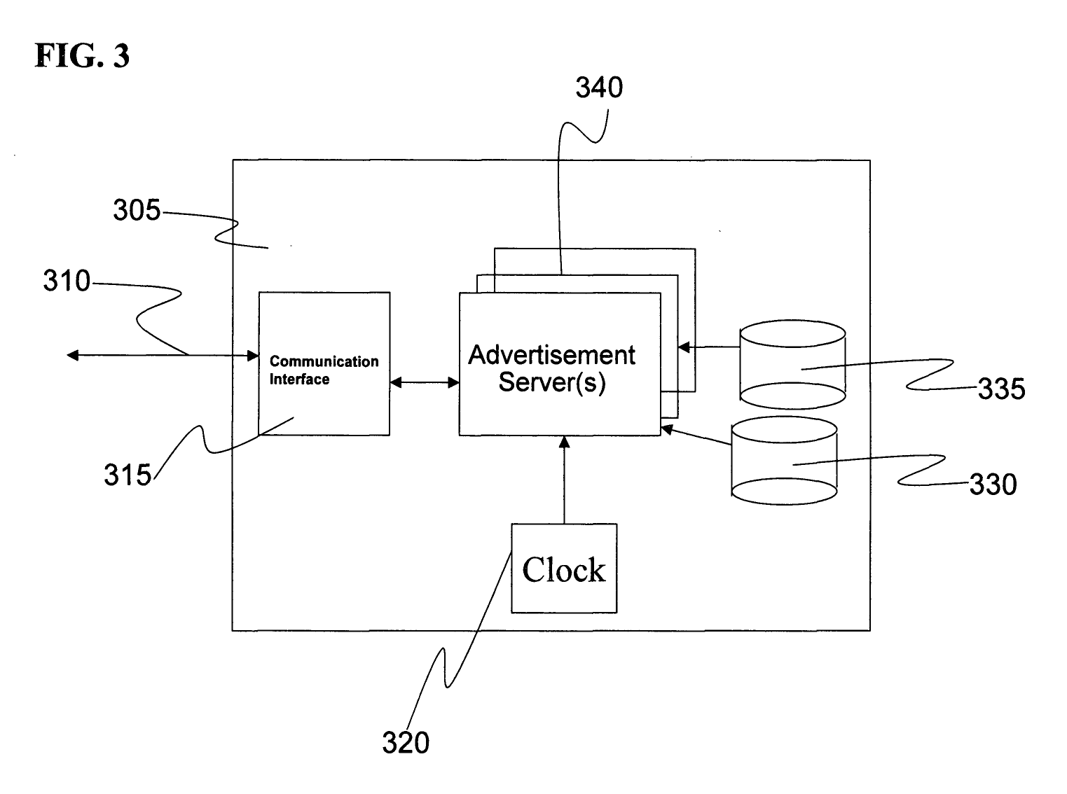

FIG. 3 presents a simplified semi-schematic block diagram of an Advertisement Server system 305 in accordance with this invention. The Advertisement Server system is connected to a plurality of user devices 105 and the Microblog Server system 205 via the communication link 310 and a communication interface 315. The Advertisement Server System consists of one or more Advertisement Server(s) 340 that provide advertisements for users in accordance with this invention. Each Advertisement Server is connected to a User Characterization Database 330 that stores the characteristics of user as are relevant to providing relevant advertisements in accordance with this invention. Each Advertisement Server is also connected to an Advertisement Database 335 which is a repository of currently available advertisements. It will be appreciated that FIG. 3 is not prescriptive in terms of the software or hardware architecture to be used to derive the benefits of this invention. The functional elements in FIG. 3 may be distributed across multiple hardware and software systems. Advertisements can be requested by the user device 105 directly from the Advertisement Server system 305, or alternatively the Microblog Server system 205 could request the advertisements from the Advertisement Server system 305 and combine the advertisements with information to be sent to the user device for display. Alternatively, the user device 105 may interact with a proxy server which in turn could interact with the Microblog Server system 205 and Advertisement Server system 305, obtain results from these, then combine them and send to the user device for display to the user.

Operation of a particular embodiment in accordance with the practice of principles of this invention will be described below. Each user who wants to use the service will be required to create a unique User Id and associated credential information (such as a password, PIN, etc). The unique User Id is used to identify the user and to provide relevant contextual advertisements. Each user is also required to specify the users whose microblogs he is intending to subscribe to. Optionally, when a user A subscribes to another user B's microblogs, he can be requested to specify the topics he would like to follow from B's microblogs. For example, user A may specify that he is following B because of B's views on “fashion”. Once the user is admitted to the system, he can log into the system and then microblog by entering the text he wants to microblog using the keypad 115 in the user device 105. The user device conveys this microblog to the Microblog Server 205. The Microblog Server 205 stores the user's microblog in the microblog store 225 along with the current time information from the clock 220. When the user wants to read microblogs, he issues a corresponding command from the user device 105. This request is conveyed to the Microblog Server 205, which identifies the users to whose microblogs this user has subscribed to by looking into the User Relationship database 230. The Microblog Server then looks into the microblog store 225 for microblogs from these users and provides the most recent microblogs from these users to the user device 105 for display. At any time information is displayed to the user, one or more relevant contextual advertisements can be displayed to the user in accordance with the principles of this invention as described below. It must be noted that the principles listed below are not mutually exclusive, nor is there any requirement that they be applied only one at a time. At any given time, when a request for advertisements is made, multiple advertisements could be selected based on the principles below, and the advertisements that are expected to generate the highest economic value for the business entity operating the service can be displayed to the user.

In accordance with the principles of this invention, advertisers specify the following when providing their advertisements to the microblogging service: the advertisement itself which may include the advertisement media such as text, image, video, etc; action to be performed when the user selects the advertisement (e.g click through), price the advertiser is willing to pay the microbloging service when the advertisement is displayed and/or selected by the user; and optionally one or more of the following: the set of keywords related to the advertisement, general topic area related to the advertisement, demographics of users to be targeted, and lifestyle activity corresponding to the product being advertised. For example, a fast-food restaurant chain may provide an advertisement that has “Big Value Meal for $2.99” as the media, click through to a promotion web site as the action, $0.20 per user's click on the ad, “meal, value, restaurant, lunch, dinner” as the keywords, “fast food” as the topic, males 18-34 as the preferred demography, and “eating” as the related activity.

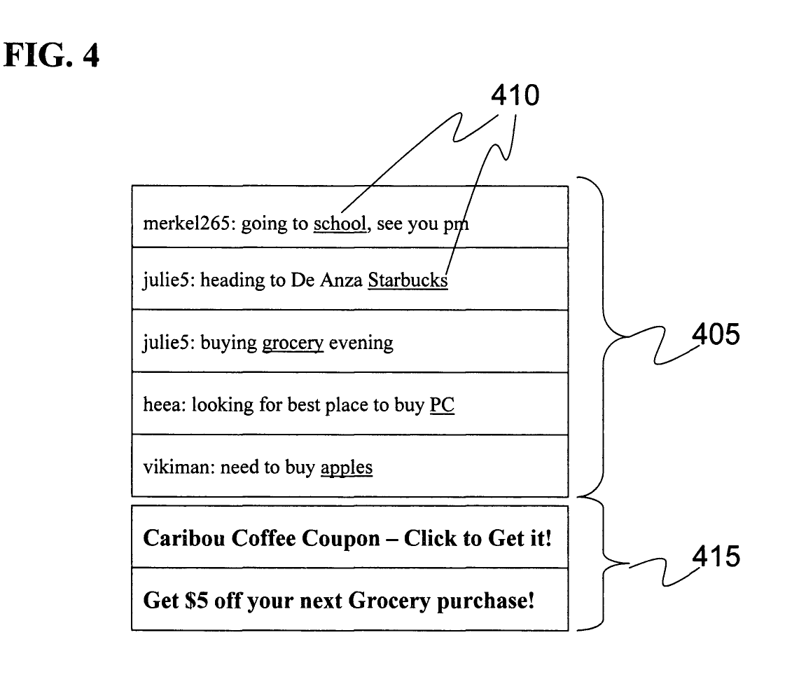

In one preferred embodiment of this invention, the microblogs that are to be displayed on the user device upon the user's request based on the users this user is following are analyzed and keywords from those microblogs are extracted. The Microblog Server system 205 then communicates these keyword(s) to the Advertisement Server system 305. This communication can happen after the user device sends a requests or it could be done a priori, for example, periodically even before the user request, with the keywords being stored in the User Characterization Database 330. Upon receiving a request for advertisements, the Advertisement Server system then identifies the advertisements in the Advertisement Database 335 that have one or more matching keyword(s) that match the keyword(s) extracted from the microblogs to be displayed. The selected advertisements are then ranked on the basis of the expected commercial value to the microblogging service. The expected commercial value can be obtained by multiplying the price the advertiser is willing to pay for the advertisement upon user action, with the probability that the user will act on the advertisement. For example, if the price the advertiser is willing to pay if the user clicks on the advertisement is $0.20 and the expected probability that the user may click on the advertisement is 0.50, then the expected commercial value of the advertisement is $0.20×0.50=$0.10. If another advertiser has bid a price of $0.15 whenever the given advertisement is simply displayed to the user, then the expected commercial value upon display is $0.15×1.0=$0.15. Once the advertisements are ranked based on their expected commercial value, the number of advertisements that can be displayed on the user device is determined, and that number of advertisements are selected from the top of the ranked list and sent to the user device for display to the user. FIG. 4 shows an example of an embodiment of this principle. 405 shows the set of microblogs from the users for whose microblogs this user has subscribed to. The keywords extracted from these microblogs are highlighted in FIG. 4 as underlined text, such as 410. 415 shows an example of advertisements selected for presentation to the user based on the keywords associated with these ads (example, Starbucks, Grocery) and the keywords appearing in microblogs 405 selected for display.

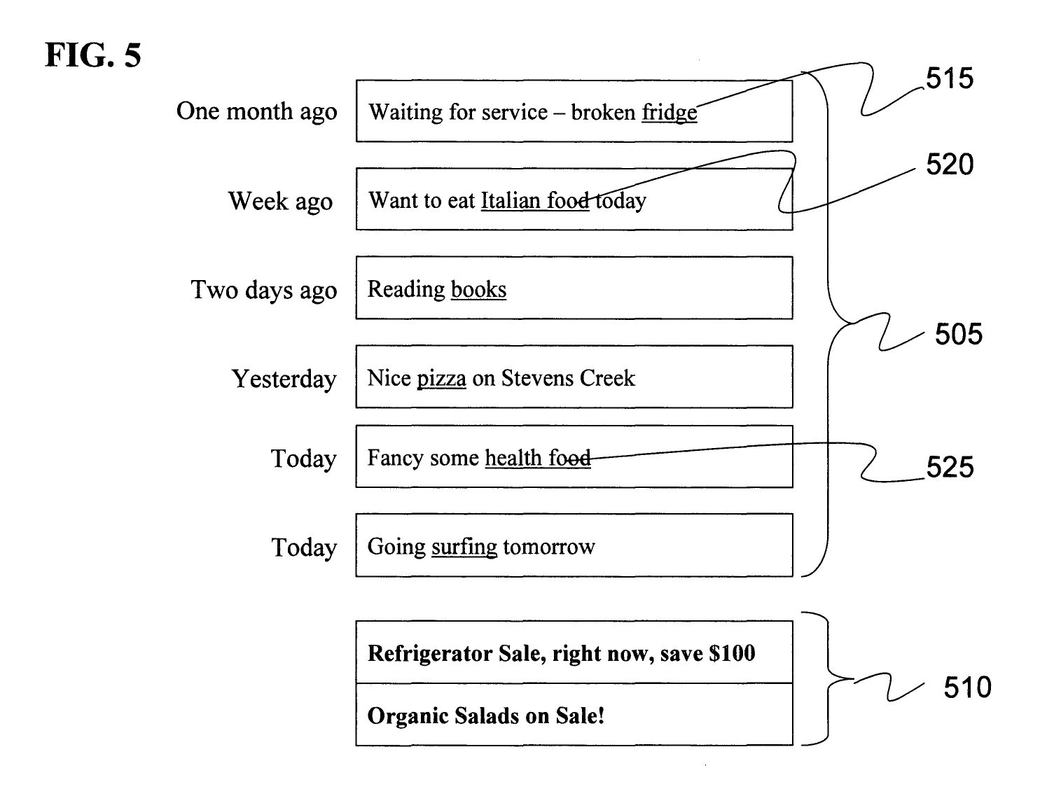

In another preferred embodiment of this invention, the microblogs that have been generated by the user in the past are analyzed and keywords from those microblogs are extracted. The extracted keywords are then aged based on the time of the corresponding microblog and the nature of the keyword. Keywords that are expected to be current are retained and others dropped from consideration. For example, keywords associated with food may have a shorter life span whereas keywords associated with capital goods may have longer life span. Once a set of keywords is so assembled, the Microblog Server system 205 then communicates these keyword(s) to the Advertisement Server system 305. This communication can happen after the user device sends a requests or it could be done a priori, for example, periodically even before the user request, with the keywords being stored in the User Characterization Database 330. The Advertisement Server system then identifies the advertisements in the Advertisement Database 335 that have one or more keyword(s) that match the keyword(s) extracted from the user's own microblogs as above. The selected advertisements are then ranked on the basis of the expected commercial value to the microblogging service. Once the advertisements are ranked based on their expected commercial value, the number of advertisements that can be displayed on the user device is determined, and that number of advertisements are selected from the top of the ranked list and sent to the user device for display to the user on display 110. FIG. 5 shows an example of an embodiment of this principle. 505 shows the set of microblogs generated by the user, along with the time frames in which they were generated. The keywords extracted from these microblogs are highlighted in FIG. 5 with underlined text, such as 515. The keyword “fridge” 515 about the refrigerator is retained as it is considered to be long lasting whereas the keyword “italian food” 520 is dropped from consideration since it is about food and the microblog was from a week ago. 510 shows the advertisements selected for presentation to the user based on the keywords associated with these ads (example, fridge, health food) and the keywords appearing in the user's own microblogs 505 selected for display and filtered based on the age of the microblog and the type of keyword as discussed above.

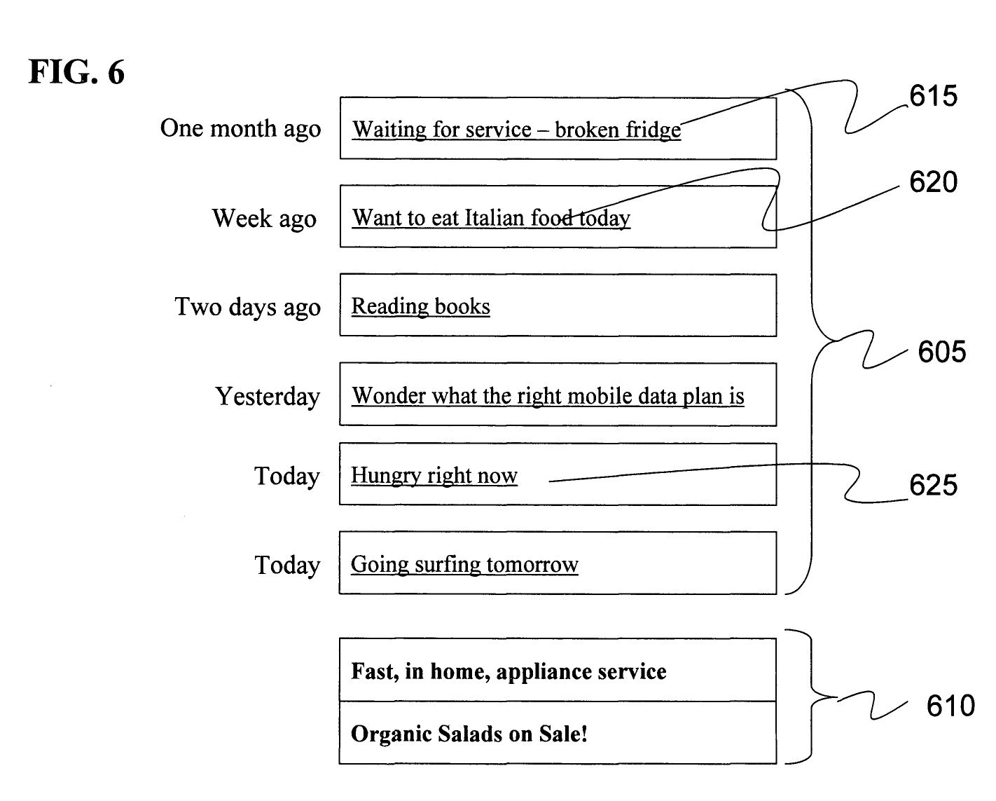

In another preferred embodiment of this invention, the user's microblogs are analyzed using natural language processing techniques to generate a list of user's needs and aged depending upon the type of need. The needs are then filtered based on aging criteria so that those needs that are likely to be current are retained. Once a set of needs is so assembled, the Microblog Server system 205 then communicates these keyword(s) to the Advertisement Server system 305. This communication can happen after the user device sends a request or it could be done a priori, for example, periodically even before the user request, with the user needs being stored in the User Characterization Database 330. The Advertisement Server system 305 then identifies the advertisements in the Advertisement Database 335 that satisfy the identified needs. The selected advertisements are then ranked on the basis of the expected commercial value to the microblogging service. Once the advertisements are ranked based on their expected commercial value, the number of advertisements that can be displayed on the user device is determined, and that number of advertisements are selected from the top of the ranked list and sent to the user device for display. FIG. 6 shows an example of an embodiment of this principle. Microblog 615 by the user indicates a need for an efficient appliance service. Microblog 620 for Italian food is considered to be a limited time need for a specific type food and is dropped from consideration as a need. Microblog 625 is analyzed and a need for food is identified as a current need and included for consideration. Based on the above needs, and a consideration of the expected commercial value, an advertisement for an appliance service and another for organic salads 610 are selected and displayed to the user.

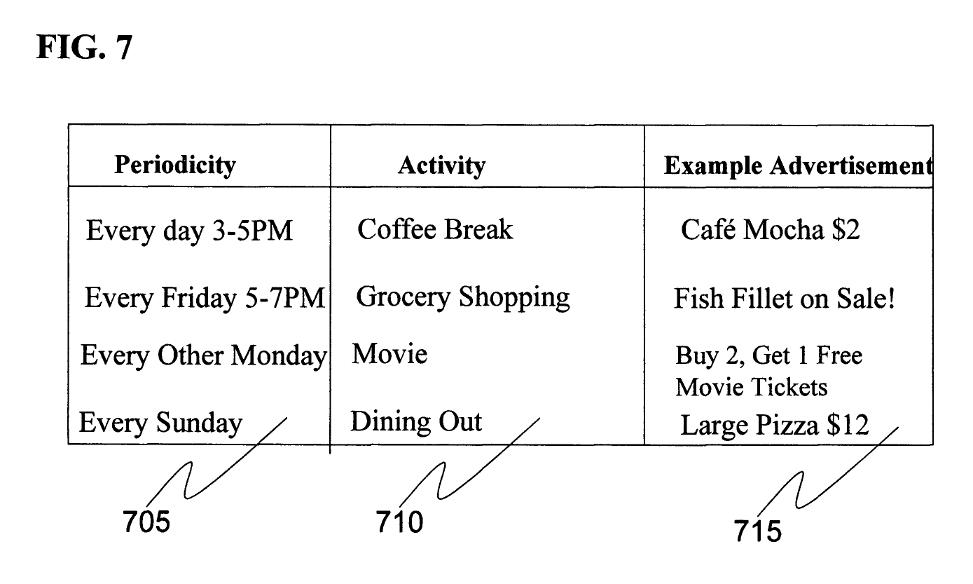

In another preferred embodiment of this invention, microblogs from the user are analyzed to identify underlying time patterns of user activities. A mapping between periodic times and corresponding activities of the user as mentioned in his microblog is then generated. This is provided to the Advertising Server system 305 and stored in the User Characterization Database 330. Advertisers submit activity relationships of the products that are being advertised in their advertisements. For example, an advertisement for a coffee shop may include the corresponding activity as “Coffee Break”. When a request is made to the Advertisement Server system 305 for advertisements for a given user, the likely activities the user could be engaged in currently is generated from the periodic time-activity mapping for that user by using the current time indicated by clock 320. Advertisements that correspond to those activities are selected to be considered for presentation to the user. The selected advertisements are then ranked on the basis of the expected commercial value to the microblogging service. Once the advertisements are ranked based on their expected commercial value, the number of advertisements that can be displayed on the user device is determined, and that number of advertisements are selected from the top of the ranked list and sent to the user device for display to the user. FIG. 7 shows an example of an embodiment of this principle where specific periodicity items are connected with expected user activity and suitable advertisements. The periodicity and the corresponding activities are presented in 705 and 710 respectively.

In another preferred embodiment of this invention, the microblogs in the microblogging service as a whole or those corresponding to a specific geographical area are analyzed to identify major trends and events being microbloged at the moment. Keywords that occur most often in the system among microblogs corresponding to such events are identified. Advertisements that have matching keywords are selected for consideration. The selected advertisements are then ranked on the basis of the expected commercial value to the microblogging service. Once the advertisements are ranked based on their expected commercial value, the number of advertisements that can be displayed on the user device is determined, and that number of advertisements are selected from the top of the ranked list and sent to the user device for display to the user on display 110. As an example, if microblogs indicate a financial crisis breaking out, advertisements for safe investment options may be selected for consideration.

In another preferred embodiment of this invention, the microblogs of the given user, the users to whose microblogs he has subscribed to, and the users who have subscribed to this user are analyzed to identify phrase usage, slangs, and products discussed. These are then matched with phrase usages, slangs, and products that can be associated with specific demographies. Based on such a match, the user's likely demography is identified and noted in the User Characterization Database 330. When a request is made to the Advertisement Server system 305 for advertisements for a given user, advertisements that have been marked by advertisers as being targeted to the user's likely demography are considered for presentation to the user. The selected advertisements are then ranked on the basis of the expected commercial value to the microblogging service. Once the advertisements are ranked based on their expected commercial value, the number of advertisements that can be displayed on the user device is determined, and that number of advertisements are selected from the top of the ranked list and sent to the user device for display to the user on display 110.

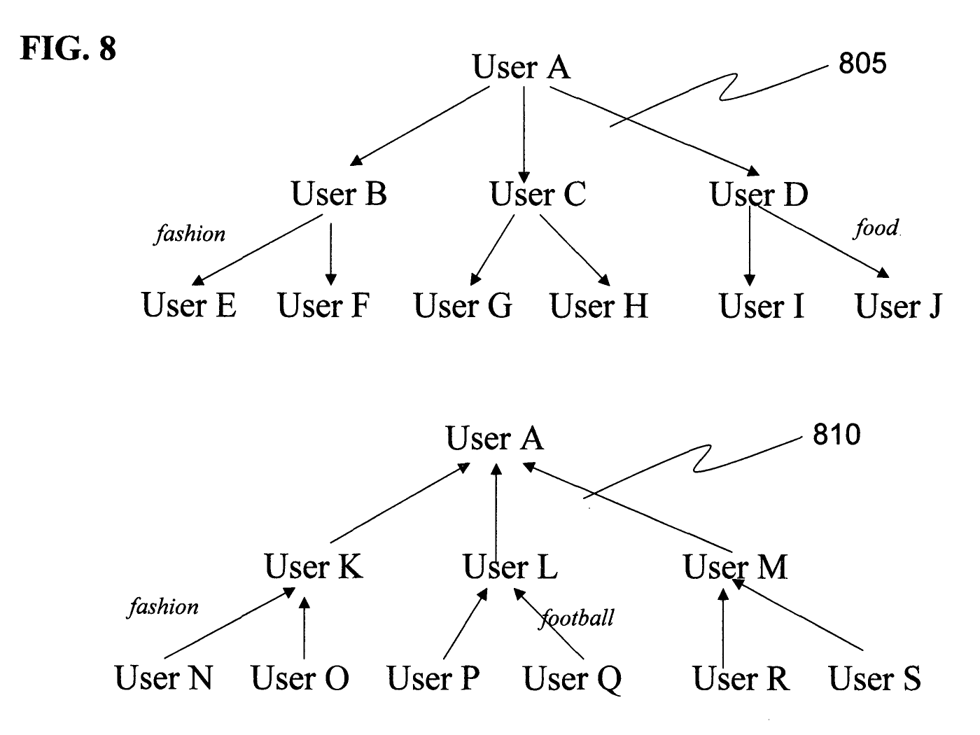

In one preferred embodiment of this invention the User Relationship Database 230 is analyzed to identify topics in which the user is most interested. Useful advertisement targeting information can be extracted by identifying users who the current user is following, as well as identifying users who are following the current user. FIG. 8 illustrates an example of this approach. 805 shows in a graphical form, the relationships of User A with those whose microblogs User A is following, in this example—User B, User C, and User D, and further the users who these users in turn are following. User A may be following certain users purely on an acquaintance basis, but may be following others based on their expertise on a topic of interest to the user. Experts on topics typically have a large number of “followers”, that is, users who follow their microblogs. So, in an embodiment of this invention, the users whom the given user is following is analyzed to find those users with a very high number of followers or those with a large number of microblogs. This analysis is continued for a few more levels in addition to the immediate next level. By analyzing the microblogs of users who are being followed by this user for keywords that pertain to topics of relevance, interests of this particular user can be found. Topics declared by the user when adding a user to follow are also included, example “fashion” and “food” in FIG. 8. These topics of interest to the user identified by analyzing the “follower” relationship are stored in the User Characterization Database 330. A similar analysis can also be made by looking at the subscriptions links of those who have subscribed to follow this user's microblogs as in 810. When a request is made to the Advertisement Server system 305 for advertisements for a given user, advertisements that have been marked by advertisers as being in the topic of interest to the given user (as stored in the User Characterization Database 330) are considered for presentation to the user. The selected advertisements are then ranked on the basis of the expected commercial value to the microblogging service. Once the advertisements are ranked based on their expected commercial value, the number of advertisements that can be displayed on the user device is determined, and that number of advertisements are selected from the top of the ranked list and sent to the user device for display.

In one preferred embodiment of this invention, the GPS coordinates obtained form the GPS receiver 145 in the user device is used to further determine the most appropriate advertisements from among those selected using the above principles.

What is claimed is:

1. A system and method for presenting relevant contextual advertisements for users of microblogging services; the system comprising of a user-device, a microblog server, and an advertisement server; the method comprising of deriving contextual cues that show the preferences and needs of the user based on his own microblogs, the microblogs of other users who are following the user's microblogs, and the microblogs of users whose microblogs the user is following.

2. The method of claim 1 wherein the preferences and needs of the user are determined by extracting the keywords in the microblogs of the users whose microblogs the user is following, and matching such keywords with those of advertisements in the advertisement server, such a matching process occurring either before the user accesses the system or after the user accesses the system.

3. The method of claim 1 wherein the preferences and needs of the user are determined by extracting the keywords in the microblogs the user has generated, and matching such keywords with those of advertisements in the advertisement server, such a matching process occurring either before the user accesses the system or after the user accesses the system.

4. The method of claim 3 wherein the keywords extracted are filtered based on the time at which the microblog containing the keyword was generated by the user.

5. The method of claim 3, wherein the microblogs of the user are analyzed using natural language processing techniques to determine the needs underlying each microblog and then filtering the needs based on the time horizon of the need and the time gap between when the microblog was generated and the current time, then presenting to the user advertisements that could satisfy needs that are likely to be current.

6. The method of claim 3, wherein the microblogs of the user are analyzed for periodicity of underlying needs and then advertisements are presented to the user based on the current time and the periodic pattern into which the current time fits.

7. The method of claim 3, wherein the microblogs of the user are analyzed for phrase usages, slangs, and products that can be associated with specific demographies and the likely demography of the user is identified, then advertisements that are specified for the user's demography are presented to the user.

8. A system and method for presenting relevant contextual advertisements for users of microblogging services; the system comprising of a user-device, a microblog server, and an advertisement server; the method comprising of analyzing the ‘following’ and ‘followed by' relationships in the microblogging system to extract the interests of the user at the current time and then displaying advertisements that related to those interests.

9. A system and method for presenting relevant contextual advertisements for users of microblogging services; the system comprising of a user-device, a microblog server, and an advertisement server; the method comprising of displaying advertisements related to

10. The methods of claim 1, claim 8, and claim 9 where the advertisements to be displayed are determined to maximize the expected commercial value to the microblogging service.

11. The methods of claim 1, claim 8, and claim 9 where the advertisements to be displayed are further prioritized based on the location where the user is located.
